(19) United States
(12) Patent Application Publication
(10) Pub. No.: US 2021/0357877 A1
(43) Pub. Date: Nov. 18, 2021

(54) INDICATIONS OF TIME REMAINING FOR MEETINGS

(71) Applicant: Hewlett-Packard Development Company, L.P., Spring, TX (US)

(72) Inventors: Ben A Knight, Houston, TX (US); Robert C Brooks, Houston, TX (US); Jeffrey C Stevens, Houston, TX (US)

(21) Appl. No.: 16/481,887

(22) PCT Filed: Feb. 7, 2018
(86) PCT No.: PCT/US2018/017237

§ 371 Date: Jul. 30, 2019

(51) Int. Cl. G06Q 10/10

(52) U.S. Cl. CPC G06Q 10/1095

(57) ABSTRACT

In an example implementation according to aspects of the present disclosure, a method may include receiving, at a device, timing information of a scheduled meeting, and determining time remaining for the scheduled meeting. The method further includes outputting, at the device, an indication of the time remaining at scheduled intervals.

### BACKGROUND

Utilizing a conference room for meetings, or scheduling meetings in the conference room, can be a challenging task, particularly when users are looking to use the same conference room for different meetings.

### BRIEF DESCRIPTION OF THE DRAWINGS

FIG. 1 illustrates a device for providing the indication of a meeting status of a scheduled meeting being held, according to, an example;

FIG. 2 illustrates a method at a device for providing the indication of a meeting status, of a scheduled meeting being held, according to an example; and

FIG. 3 is a flow diagram accordance with an example of the present disclosure.

### DETAILED DESCRIPTION

Although a conference room may be scheduled in advance, issues may still arise, such as meetings running over into another scheduled meeting. Examples disclosed herein provide a conference room solution that provides an indication of the meeting status of a scheduled meeting being held in the conference room. As an example, the meeting status may convey time remaining in the scheduled meeting, As a result, participants in the conference room may become aware of the time remaining for the scheduled meeting, in order to efficiently manage the time remaining in the meeting and end the meeting on time. As a result, participants that may be waiting outside the conference room will be able begin their meeting as scheduled, promoting better meeting etiquette. As will be further described, the indication provided may vary at scheduled intervals prior to the end of the scheduled time. For example, if the indication includes lighting to be output at a device (e.g., via a light pipe), behavior of the lighting, such as the color and a frequency of how often the light is output, may vary at each scheduled interval.

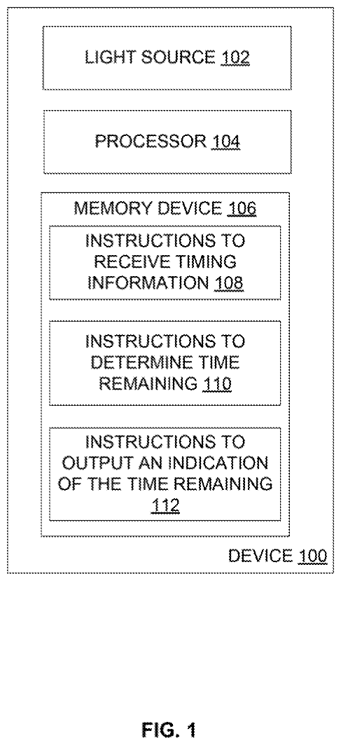

With reference to the figures, FIG. 1 illustrates a device 100 for providing the indication of a meeting status of a scheduled meeting being held, for example, in a conference room. The device 100 may correspond to a telecommunications device, with a light source 102 associated with the device 100. As will be further described, the light source 102 may be integral with the device 100, and used as a visual indicator to provide the meeting status to participants in the conference room. The light source 102 may emit light via a medium, such as a light pipe. The shape of the light pipe may vary. However, as an example, for the visual indicator to be clearly visible around the conference room, the light pipe may be circular, such as a light ring. Examples of the telecommunications device include, but are not limited to, a speakerphone or a computing device designed for conferencing

The device 100 depicts a processor 104 and a memory device 106 and, as an example of the device 100 performing its operations, the memory device 106 may include instructions 108-112 that are executable by the, processor 104. Thus, memory device 106 can be said to store program instructions that, when executed by processor 104, implement the components of the device 100. The executable program instructions stored in the memory device 106 include, as an example, instructions to receive timing information (108), instructions to determine time remaining (110), and instructions to output an indication of the time remaining (112).

Instructions to receive timing information (108) represent program instructions that when executed by the processor 104 cause the device 100 to receive timing information, for example, of a scheduled meeting being held in a conference room. As an example, the timing information may correspond to when the meeting is scheduled to end. This timing information may be obtained, for example, from various applications loaded on the device 100, such as a calendar application, or a communication software holding the scheduled meeting. For example, the communication software may be holding a teleconference for participants in the conference room, with scheduling information of meetings to be held in the conference room.

In addition to relying on applications loaded on the device 100 for receiving the timing information, the device 100 may rather receive the timing information autonomously from another device (e.g., a second device), upon the second device coming within proximity of the device 100, according to an example. For example, as participants gather for a scheduled meeting in the conference room, the second device belonging to one of the participants, such as a mobile device or notebook, computer, may autonomously transmit the timing information of the scheduled meeting to the device 100 upon the participant entering the conference room or initiating a teleconference on the device 100. The timing information from the second device may originate from a calendar application loaded on the second device, which includes a calendar entry corresponding to the scheduled meeting.

Instructions to determine time remaining (110) represent program instructions that when executed by the processor 104 cause the device 100 to determine time remaining for the scheduled meeting, for example, based on the timing information received. As will be further described, based on the amount of time remaining, an indication of the meeting status may be output via the light source 102 at scheduled intervals. For example, a first type of indication may be provided by the light source 102 when fifteen minutes remain in the scheduled meeting, a second type of indication may be provided when five minutes remain, and finally a third type of indication may be provided when no time is remaining in the scheduled meeting (e,g., end of the scheduled time).

Instructions to output an indication of the time remaining (112) represent program instructions that when executed by the processor 104 cause the device 100 to output, for example, via the light source 102, an indication of the time remaining at scheduled intervals (e.g., fifteen minutes prior, five minutes prior, and at end of time for scheduled meeting). As an example, a behavior of lighting output via the light source 102 at each scheduled interval may have different parameters, in order to clearly inform participants in the conference room how much time is remaining for the scheduled meeting. Examples of the different parameters of the light output via the light source 102 may include different colors and a frequency of how often the light is output via the light source 102 during a particular scheduled interval. For example, the light source 102 could be programmed to start flashing yellow when 15 minutes are, left in the scheduled meeting, and then flash at a faster rate as the time gets closer to expiring, for example, when five minutes remain. Finally, when there is no time remaining for the scheduled meeting, the light source 102 may then flash red. Although three scheduled intervals are described, any number of scheduled intervals may be used for providing varied indications via the light source 102.

By using different parameters of the light output via the light source 102 at each scheduled interval, participants in the conference room may become aware of the time remaining for the scheduled meeting, in order to efficiently manage the time remaining in the meeting and end the meeting on time. As a result, participants that may be waiting outside the conference room will be able begin their meeting as scheduled, promoting better meeting etiquette.

Memory device 106 represents generally any number of memory components capable of storing instructions that can be executed by processor 104. Memory device 106 is non-transitory in the sense that it does not encompass a transitory signal but instead is made up of at least one memory component configured to store the relevant instructions. As a result, the memory device 106 may be a non-transitory computer-readable storage medium. Memory device 106 may be implemented in a single device or distributed across devices. Likewise, processor 104 represents any number of processors capable of executing instructions stored by memory device 106. Processor 104 may be integrated in a single device or distributed across devices. Further, memory device 106 may be fully or partially integrated in the same device as processor 104, or it may be separate but accessible to that device and processor 104.

In one example, the program instructions 108-112 can be part of an installation package that when installed can be executed by processor 104 to implement the components of the device 100. In this case, memory device 106 may be a portable medium such as a CD, DVD, or flash drive or a memory maintained by a server from which the installation package can be downloaded and installed. In another example, the program instructions may be part of an application or applications already installed. Here, memory device 106 can include integrated memory such as a hard drive, solid state drive, or the like.

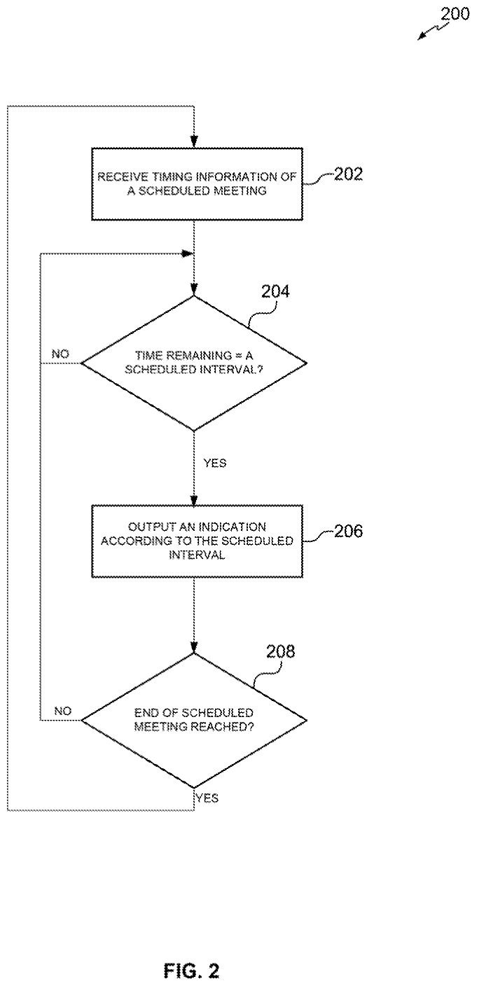

FIG. 2 illustrates a method 200 at a device for providing the indication of a meeting status of a scheduled meeting being held, for example, in a conference room. In discussing FIG. 2, reference may be made to the example device 100 illustrated in FIG. 1. Such reference is made to provide contextual examples and not to limit the manner in which method 200 depicted by FIG. 2 may be implemented.

Method 200 begins at 202, where the device receives timing information of the scheduled meeting being held in the conference room. As an example, the timing information may correspond to when the meeting is scheduled to end. As described above, this timing information may be obtained, for example, from various applications loaded on the device, such as a calendar application, or a communication software holding the scheduled meeting. In addition, the device may rather receive the timing information autonomously from another device (e.g., a second device), upon the second device coming within proximity of the device. The timing information from the second device may originate from a calendar application loaded on the second device, which includes a calendar entry corresponding to the scheduled meeting.

At 204, the device determines whether the time remaining for the scheduled meeting equals a scheduled interval for providing a meeting status indication. By providing an indication of the time remaining at scheduled intervals, participants in the conference room may become aware of the time remaining for the scheduled meeting (e.g., fifteen minutes remaining, five minutes remaining, end of scheduled time reached), in order to efficiently manage the time remaining in the meeting and end the meeting on time. Any number of scheduled intervals may be used for providing varied indications during the scheduled meeting

At 206, if the time remaining for the scheduled meeting equals a scheduled interval for providing a meeting status indication, the device outputs an indication according to the scheduled interval. Referring to device 100, light source 102 may be used as a visual indicator to provide the meeting status indication to participants in the conference room. In order to provide varied indications, at each scheduled interval, a behavior of lighting output via the light source 102 at each scheduled interval may have different parameters, in order to clearly inform participants in the conference room how much time is remaining for the scheduled meeting. Examples of the different parameters of the light output via the light source 102 may include different colors and a frequency of how often the light is output via the light source 102 during a particular scheduled interval. For example, the light source 102 could be programmed to start flashing yellow when 15 minutes are left in the scheduled meeting, and then flash at a faster rate as the time gets closer to expiring, for example, when five minutes remain. Finally, when there is no time remaining for the scheduled meeting, the light source 102 may then flash red.

At 208, the device determines whether the end of the scheduled meeting has been reached. If not, the device returns to 204 to determine whether the time remaining equals a scheduled interval. For example, after flashing yellow when fifteen minutes are left in the scheduled meeting, once the device determines that five minutes remain, the light source 102 may begin flashing at a faster rate, in order to inform participants in the conference room of the time remaining. Similarly, upon returning to 204, once device determines that no time remains'for the scheduled meeting, the final scheduled interval, the light source 102 may then flash red, indicating to the participants in the conference room that there is no time remaining. At 208, once the device determines that no time remains, the device returns to 202 to collect timing information of the next scheduled meeting.

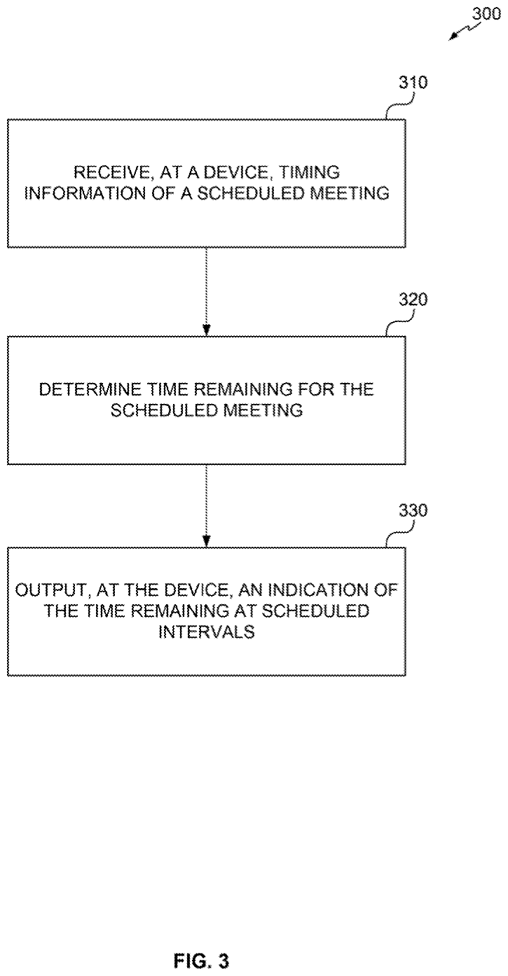

FIG. 3 is a flow diagram 300 of steps taken by a device to implement a method for providing the indication of a meeting status of a scheduled meeting being held in a conference room, according to an example. Although the flow diagram of FIG. 3 shows a specific order of execution, the order of execution may differ from that which is depicted. For example, the order of execution of two or more blocks or arrows may be scrambled relative to the order shown. Also, two or more blocks shown in succession may be executed concurrently or with partial concurrence. Ali such variations are within the scope of the present invention.

At 310, the device receives timing information of a scheduled meeting. As an example, the timing information may correspond to when the meeting is scheduled to end. As described above, this timing information may be obtained, for example, from various applications loaded on the device, such as a calendar application, or a communication software holding the scheduled meeting. In addition, the device may rather receive the timing information autonomously from another device (e.g., a second device), upon the second device coming within proximity of the device. The timing information from the second device may originate from a calendar application loaded on the second device, which includes a calendar entry corresponding to the scheduled meeting.

At 320, the device determines the time remaining for the scheduled meeting, for example, based on the timing information received. At 330, the device outputs an indication of the time remaining at scheduled intervals. For example, a first type of indication may be provided by the light source 102 when fifteen minutes remain in the scheduled meeting, a second type of indication may be provided when five minutes remain, and finally a third type of indication may be provided when no time is remaining in the scheduled meeting (e.g., end of the scheduled time). Although three scheduled intervals are described, any number of scheduled intervals may be used for providing varied indications via the light source 102.

As an example, the device outputs the indication via a light source of the device (e.g., light source 102 of device 100). A behavior of the lighting output via the light source at each scheduled interval may have different parameters. As an example, the different parameters include different colors and a frequency of how often the light is output via the light source. As an example of different behaviors of the lighting output via the light source at each scheduled interval, the light source could be programmed to start flashing yellow when 15 minutes are left in the scheduled meeting, and then flash at a faster rate as the time gets closer to expiring, for example, when five minutes remain. Finally, when there is no time remaining for the scheduled meeting, the light source may then flash red,

It is appreciated that example examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessary obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the scope of the disclosure. Thus, the present disclosure is not intended to be limited to the examples shown herein but is to be accorded the widest scope consistent with the principles and novel features disclosed herein.

What is claimed is:

1. A method comprising:
receiving, at a first device, timing information of a scheduled meeting;
determining time remaining for the scheduled meeting; and
outputting, at the first device, an indication of the time remaining at scheduled intervals.

2. The method of claim 1, wherein receiving comprises receiving the timing information from a communication software holding the scheduled meeting.

3. The method of claim 1, wherein receiving comprises autonomously receiving the timing information from a second device upon the second device coming within proximity of the first device.

4. The method of claim 3, wherein the timing information from the second device comprises a calendar entry corresponding to the scheduled meeting.

5. The method of claim 1, wherein outputting the indication comprises outputting the indication via a light source.

6. The method of claim 5, wherein a behavior of lighting output via the light source at each scheduled interval has different parameters.

7. The method of claim 6, wherein the different parameters comprise different colors and a frequency of how often the light is output via the light source.

8. A device comprising;
a light, source; and
a processor to:
receive timing information of a scheduled meeting;
determine time remaining for'the scheduled meeting; and
output an indication of the time remaining at scheduled intervals via the light source.

9. The device of claim 8, wherein a behavior of lighting output via the light source at each scheduled interval has different parameters.

10. The device of claim 9, wherein the different parameters comprise different colors and a frequency of how often the light is output via the light source.

11. The device of claim 8, wherein the processor to receive comprises receiving the timing information from a communication software holding the scheduled meeting.

12. The device of claim 8, wherein the processor to receive comprises autonomously receiving the timing information from a second device upon the second device coming within proximity of the first device.

13. A non-transitory computer-readable storage medium comprising program instructions which, when executed by a processor, cause the processor to:
receive timing information of a scheduled meeting;
determine time remaining for the scheduled meeting; and
output an indication of the time remaining at scheduled intervals via a light source, wherein a behavior of lighting output via the light source at each scheduled interval has different parameters.

14. The non-transitory computer-readable storage medium of claim 13, wherein the different parameters comprise different colors and a frequency of how often the light is output via the light source.

15. The non-transitory computer-readable storage medium of claim 13, wherein the instructions to receive comprises receiving the timing information from a communication software holding the scheduled meeting.
